(19) United States
(12) Patent Application Publication
(10) Pub. No.: US 2023/0044799 A1
(43) Pub. Date: Feb. 9, 2023

(54) METHOD AND DEVICE FOR MONITORING THE OPERATION OF A PAIR OF TURBOPROP ENGINES THROUGH THE NUMERICAL PROCESSING OF AN ACOUSTIC MAGNITUDE

(71) Applicant: LEONARDO S.P.A., Roma (IT)

(72) Inventor: Felice MENAFRO, ROMA (RM) (IT)

(21) Appl. No.: 17/861,771

(22) Filed: Jul. 11, 2022

(30) Foreign Application Priority Data
Jul. 23, 2021 (IT) 102021000019682

(51) Int. Cl. G01M 15/14; B64D 27/02; B64D 47/00; F02C 6/20

(52) U.S. Cl. CPC G01M 15/14; B64D 27/02; B64D 47/00; F02C 6/206

(57) ABSTRACT

Method for monitoring the operation of a pair of turboprop engines of an aircraft comprising the steps of: detecting the sound pressure generated by the first or second turboprop engine generating a respective first or second signal x(t); iteratively calculating by means of a function Rx/Ry the similarity between the first/second signal x(t)/y(t) at a time T1 and at a time T2 subsequent to time T1; and storing the degrees of similarity calculated in successive iterations in order to detect situations of normal operation of the engines when the degrees of similarity fall in successive iterations within the interval of a first value and to detect a potential fault situation in the engines when the degrees of similarity depart from this interval.

### CROSS-REFERENCE TO RELATED APPLICATIONS

This patent application claims priority from Italian patent application no. 102021000019682 filed on Jul. 23, 2021, the entire disclosure of which is incorporated herein by reference.

### FIELD OF THE INVENTION

The present invention relates to a method and a device for monitoring the operation of a pair of turboprop engines through the numerical processing of an acoustic magnitude.

### BACKGROUND OF THE INVENTION

Studies conducted on aeronautical propulsion have shown that turbo-prop technologies (aeronautical engine consisting of an aeronautical propeller driven by a turbine) have lower fuel consumption than turbofan technologies (which is known to be a particular category of turbojet engine using two separate airflows).

Although turboprop engines are not able to achieve cruising performances comparable to those of the turbofan engines, they have maximum thermodynamic efficiency at typical operating speeds for regional flights and lend themselves to the integration into the hybrid propulsion.

On the other hand, turboprop engines require continuous monitoring of the performances provided to predict faulty operations well in advance.

For example, the US Federal Specification FAR Part 43 Appendix D stipulates in relation to the inspection of turboprop propulsion to “ . . . perform an inspection annually or every 100 flight hours regarding the following events: cracks, fissures, oil leaks, . . . ”; for this reason the turboprop engines are subjected to periodic scheduled maintenance regardless of the detection of faults.

Aim of the present invention is to realise a method and a device for monitoring the operation of a pair of turboprop engines (a pair or previous one) through the numerical processing of an acoustic magnitude, in particular sound pressure levels acquired in flight.

European Patent Application EP2305958B1 describes a method in which the sound pressure level generated by the flying turboprop engines for a predefined operating speed is measured by analysing and comparing, in the time domain, the stored behaviour of the turboprop engines or by comparing them in pairs. One or more of the stored impact sounds correspond to unfavourable weather conditions. The method involves determining whether the noise of the particle impacts corresponds to one or more stored impact sounds.

Aim of the Present Invention.

The foregoing aim is achieved by the present invention in that it relates to a method and a device for monitoring the operation of a pair of turboprop engines through the numerical processing of an acoustic magnitude of the type described in claims 6 and 1.

### BRIEF DESCRIPTION OF THE DRAWINGS

FIG. 1 shows, in simplified cross-section, an aircraft propelled by a pair of turboprop engines; and

FIG. 2 shows a variant of the aircraft shown in FIG. 1.

### DESCRIPTION OF THE PREFERRED EMBODIMENT EXAMPLE

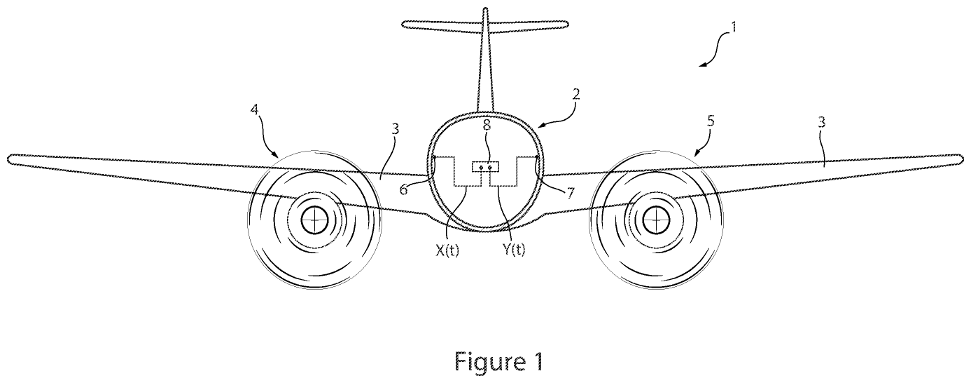

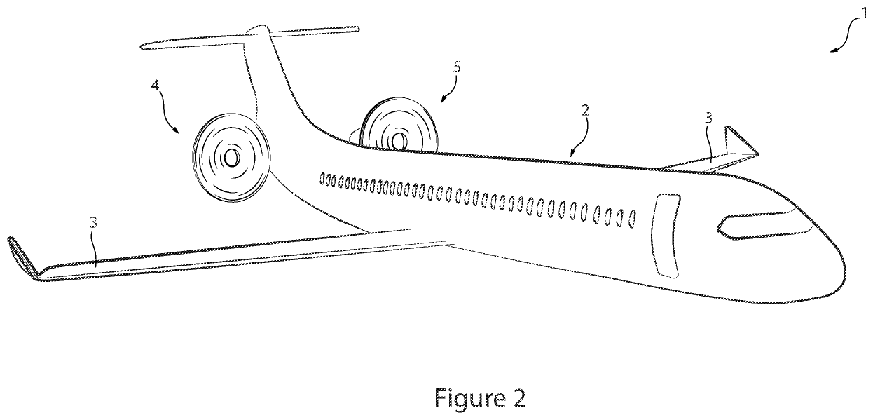

In FIG. 1, the numeral 1 denotes an aircraft (of known type) which comprises a fuselage 2 provided with a pair of wings 3. The aircraft is provided with a first turboprop engine 4 and with a second turboprop engine 5 which in the example described are arranged below the wings. However, the arrangement of the engines could be different, e.g. they could be arranged at the tail of the aircraft and arranged on the opposite side of a T-shaped tail assembly (see FIG. 2). According to the present invention there is provided a first acoustic sensor 6 (typically a microphone arranged flush with the fuselage) configured to detect the sound pressure generated by the first turboprop engine 4 generating a respective first polytonal signal x(t) and a second acoustic sensor 7 (typically a microphone arranged flush with the fuselage) configured to detect the sound pressure generated by the second turboprop engine 5 generating a respective second polytonal signal y(t). The sensors 6 and 7 are arranged on opposite sides of the fuselage 2 of the aircraft and are arranged in front of the plane of the propellers of the first and second engines 4,5 with respect to the front portion of the fuselage 2.

An electronic processing unit 8 receives, at input, the first and second signals x(t),y(t) and provides, at output, data indicative of the operating state of the first and/or second turbo-prop engine 4 and 5. The electronic unit 8 is also conveniently designed to record flight parameters such as altitude, cruising speed, route, etc.

According to the present invention, the electronic unit 8 is configured to iteratively calculate by means of a function Rx the similarity between the first signal x(t) at a time T1 and the first signal at a time T2 subsequent to the time T1 or, by means of a function Ry, the similarity between the second signal y(t) at a time T1 and the second signal at a time T2 subsequent to the time T1.

Typically, the function Rx is obtained by the auto-correlation function which for a signal of finite energy x is defined as:

Rₓ(t) [symbol] ∫_{-∞}^{∞}x*(τ)x(t+τ)dτ

where X*indicates the conjugated complex of x.

The function Rx Ry provides, in the interval τ(space of the delays), the degree of similarity of the first/second signal in two different times.

As is well known, a degree of similarity close to a first value 1 indicates two signals that are very similar or substantially the same, while a degree of similarity close to a second value (zero) indicates two signals that have no similarity at all.

The electronic unit 8 is designed to detect and store the degrees of similarity calculated in successive iterations in order to detect situations of normal operation of the engines when the degrees of similarity calculated in successive iterations (and therefore for successive flights) remain within a safety interval of a first value close to 1 and to detect a potential fault in the engines when the degrees of similarity calculated in successive iterations depart from this safety interval tending to a second value equal to zero and therefore lower than the first value.

These operations will be shown by the following examples.

### EXAMPLE 1

the degree of similarity ‘0’ flight hours is worth 1.000;

the degree of similarity at ‘1000’ flight hours compared to that at ‘0’ is worth 0.950 (first iteration);

the degree of similarity at ‘2000’ flight hours compared to that at ‘0’ is worth 0.900 and compared to 1000 flight hours is worth 0.92 (second iteration);

the degree of similarity at ‘5000’ flight hours compared to that at ‘0’ is worth 0.85, compared to 1000 flight hours is worth 0.87 and compared to 2000 flight hours is worth 0.88 (third iteration); and

the degree of similarity at ‘10000’ flight hours compared to that at ‘0’ is worth 0.8, compared to 1000 flight hours is worth 0.81, compared to 2000 flight hours is worth 0.83 and compared to 5000 flight hours is worth 0.86 (fourth iteration).

| Flight hours | 0 | 1000 | 2000 | 5000 | 10000 |
|---|---|---|---|---|---|
| 0 | 1.000 | | | | |
| 1000 | 0.950 | 1.000 | | | |
| 2000 | 0.900 | 0.920 | 1.000 | | |
| 5000 | 0.850 | 0.870 | 0.880 | 1.000 | |
| 10000 | 0.800 | 0.810 | 0.830 | 0.860 | 1.000 |

The data shown above indicate a slow descent of the degree of similarity within the safety interval during successive iterations and are indicative of a normal degradation of engine performances requiring an ordinary maintenance session.

### EXAMPLE 2

the degree of similarity ‘0’ flight hours is worth 1.000;

the degree of similarity at ‘1000’ flight hours compared to that at ‘0’ is worth 0.950 (first iteration);

the degree of similarity at ‘2000’ flight hours compared to that at ‘0’ is worth 0.900 and compared to 1000 flight hours is worth 0.92 (second iteration);

the degree of similarity at ‘5000’ flight hours compared to ‘0’ is worth 0.85, compared to 1000 flight hours is worth 0.82 and compared to 2000 flight hours is worth 0.84 (third iteration);

the degree of similarity at ‘10000’ flight hours compared to that at ‘0’ is worth 0.8, compared to 1000 flight hours is worth 0.69, compared to 2000 flight hours is worth 0.73 and compared to 5000 flight hours is worth 0.79 (fourth iteration).

| Flight hours | 0 | 1000 | 2000 | 5000 | 10000 |
|---|---|---|---|---|---|
| 0 | 1.000 | | | | |
| 1000 | 0.950 | 1.000 | | | |
| 2000 | 0.900 | 0.870 | 1.000 | | |
| 5000 | 0.850 | 0.820 | 0.840 | 1.000 | |
| 10000 | 0.800 | 0.690 | 0.730 | 0.790 | 1.000 |

As can be seen between 5,000 and 1,000 flight hours, there is a rapid decrease in the degree of similarity that abruptly departs from the safety interval (for example, the safety interval can vary between 1 and 0.8). There is therefore an indication to proceed ahead of the scheduled maintenance.

### EXAMPLE 3

the degree of similarity ‘0’ flight hours is worth 1.000;

the degree of similarity at ‘1000’ flight hours compared to that at ‘0’ is worth 0.950 (first iteration);

the degree of similarity at ‘2000’ flight hours compared to that at ‘0’ is worth 0.900 and compared to 1000 flight hours is worth 0.92 (second iteration);

the degree of similarity at ‘5000’ flight hours compared to ‘0’ is worth 0.85, compared to 1000 flight hours is worth 0.87 and compared to 2000 flight hours is worth 0.64 (third iteration);

the degree of similarity at ‘10000’ flight hours compared to that at ‘0’ is worth 0.8, compared to 1000 flight hours is worth 0.81, compared to 2000 flight hours is worth 0.43 and compared to 5000 flight hours is worth 0.39 (fourth iteration).

| Flight hours | 0 | 1000 | 2000 | 5000 | 10000 |
|---|---|---|---|---|---|
| 0 | 1.000 | | | | |
| 1000 | 0.950 | 1.000 | | | |
| 2000 | 0.900 | 0.920 | 1.000 | | |
| 5000 | 0.850 | 0.870 | 0.640 | 1.000 | |
| 10000 | 0.800 | 0.810 | 0.430 | 0.390 | 1.000 |

This table shows the significant worsening of the degree of similarity at 5000 hours compared to 2000 hours, which is confirmed by the further decrease to 0.43 compared to 2000 hours and 0.39 compared to 5000 hours.

In this case, immediate maintenance is required to repair a “major” fault.

In other words, the electronic unit 8 is designed to calculate the derivative of the degree of similarity between successive interactions and to detect a situation of potential danger if this derivative exceeds a value greater than a threshold.

In addition to the maintenance aid functions shown above according to the present invention, indications are also provided concerning the operation of the engines.

For this purpose, the electronic unit 8 is configured to calculate the cross-correlation function of the signals x(t) and y(t) which for two finite energy signals is defined as:

R_{xy}(t)=(x*y)(t) [symbol] ∫_{-∞}^{∞}x*(τ)y(t+τ)dτ

where X*indicates the conjugated complex of x.

The function Rxy provides, in the interval τ(space of the delays) the degree of similarity between the first and second signals and provides the pilot with an indication of the operation of the two engines which should rotate at the same rotation speed.

Since the rotation speeds of the engines are of the sinusoidal type, a high value of degree of similarity (close to 1) means that the two engines rotate at the same speed, a very low value of degree of similarity indicates that the two engines rotate at different speeds. In this case, the pilot can act manually on one of the two engines so as to reduce the speed variation.

### EXAMPLE 4

For example, the cross-correlation between the two signals x(t) and y(t) as the hours vary takes on the following values:
1-zero flight hours;
1-1000 flight hours;
1-2000 flight hours;
0.98-5000 flight hours; and
0.97-10,000 flight hours

As shown in the table below:

| Flight hours | Flight hours (TP2) | | | | |
|---|---|---|---|---|---|
| (TP1) | 0 | 1000 | 2000 | 5000 | 10000 |
| 0 | 1.000 | | | | |
| 1000 | | 1.000 | | | |
| 2000 | | | 1.000 | | |
| 5000 | | | | 0.980 | |
| 10000 | | | | | 0.970 |

The cross-correlation value therefore remains in the safe interval 1-0.8 for successive flights, although it indicates an onset of degradation after 5000 flight hours.

### NUMBERS

1 aircraft
2 fuselage
3 wings
4 first turboprop engine
5 second turboprop engine
6 first acoustic sensor
x(t) first signal
7 second acoustic sensor
8 electronic processing units

1. A device for monitoring the operation of a pair of turboprop engines of an aircraft that comprises a fuselage (2) provided with a pair of wings (3) and is provided with at least a first turboprop engine (4) and with a second turboprop engine (5); the device comprises a first acoustic sensor (6) configured to detect the sound pressure generated by the first turbo-prop engine (4) generating a respective first signal x(t) and a second acoustic sensor (7) configured to detect the sound pressure generated by the second turboprop engine (5) generating a respective second signal y(t); the device comprises an electronic processing unit (8) that receives, at input, the first and second signals x(t),y(t) and provides, at output, data indicative of the operating state of the first and/or second turboprop engine (4 and 5), characterized in that the electronic unit (8) is configured to iteratively calculate by means of a function Rx the similarity between the first signal x(t) at a time T1 and the first signal at a time T2 subsequent to the time T1 or, by means of a function Ry, the similarity between the second signal y(t) at a time T1 and the second signal at a time T2 subsequent to the time T1;
the electronic unit (8) is designed to detect and store the degrees of similarity calculated in successive iterations in order to detect situations of normal operation of the engines when the degrees of similarity calculated in successive iterations remain within a safety interval of a first value and to detect a potential fault in the engines when the degrees of similarity calculated in successive iterations depart from this safety interval tending towards a second value lower than the first value.

2. The device according to claim 1, wherein the first and second sensors (6,7) are arranged on opposite sides of the fuselage (2) of the aircraft and are arranged in front of the plane of the propellers of the first and second engines (4,5) with respect to the front portion of the fuselage (2).

3. The device according to claim 1 wherein the function Rx is obtained by the auto-correlation function defined as:
Rₓ(t) [symbol] ∫_{-∞}^{∞}x*(τ)x(t+τ)dτ
where X*indicates the conjugated complex of x.
the function Rx provides, in the space interval of the delays τ, the degree of similarity of the first/second signal in the two different times T1 and T2.

4. The device according to claim 1, wherein the electronic processing unit (8) is designed to calculate the derivative of the degree of similarity between successive interactions and to detect a potentially dangerous situation if said derivative exceeds a value greater than a threshold.

5. The device according to claim 1, wherein the electronic processing unit (8) is furthermore designed to calculate the cross-correlation function Rxy of the signals x(t) and y(t) defined as:
R_{xy}(t)=(x*y)(t) [symbol] ∫_{-∞}^{∞}x*(τ)y(t+τ)dτ
where X*indicates the conjugated complex of x.
the function Rxy provides, in the space interval of the delays τ the degree of similarity between the first and second signals and provides the pilot with an indication of the operation of the two engines which should rotate at the same rotation speed.

6. A method for monitoring the operation of a pair of turboprop engines of an aircraft, which includes a fuselage (2) provided with a pair of wings (3) and is provided with at least a first turboprop engine (4) and a second turboprop engine (5); comprising the steps of:
detecting by means of an acoustic sensor the sound pressure generated by the first turboprop engine (4) generating a respective first signal x(t);
detecting by means of an acoustic sensor the sound pressure generated by the second turboprop engine (5) generating a respective second signal y(t);
processing the first and second signals x(t),y(t) to provide data indicative of the operating state of the first and/or second turboprop engine (4 and 5),
characterized in that it comprises the steps of:
iteratively calculating, by means of a function Rx/Ry, the similarity between the first signal x(t) at a time T1 and the first signal at a time T2 subsequent to time T1 or the similarity between the second signal y(t) at a time T1 and the second signal at a time T2 following time T1;
detecting and storing the degrees of similarity calculated to detect situations of normal operation of the engines when the degrees of similarity calculated for successive iterations remain within a safety interval of a first value, and detecting a potential fault in the engines when the degrees of similarity calculated in successive iterations depart from this safety interval tending towards a second value lower than the first value.

7. The method according to claim 6 wherein the function Rx is obtained by the auto-correlation function defined as:
Rₓ(t) [symbol] ∫_{-∞}^{∞}x*(τ)x(t+τ)dτ
where X*indicates the conjugated complex of x.
the function Rx provides, in the space interval of the delays τ the degree of similarity of the first/second signal in the two different times T1 and T2.

8. The method according to claim 6 wherein the step of calculating the cross-correlation function Rxy of the signals x(t) and y(t) is foreseen defined as:
R_{xy}(t)=(x*y)(t) [symbol] ∫_{-∞}^{∞}x*(τ)y(t+τ)dτ
where X*indicates the conjugated complex of x.
the function Rxy provides, in the space interval of the delays τ the degree of similarity between the first and second signals and provides the pilot with an indication of the operation of the two engines which should rotate at the same rotation speed.

9. The method according to claim 6 comprising the step of calculating the derivative of the degree of similarity between successive interactions and detecting a potentially dangerous situation if said derivative exceeds a value above a threshold.
